(19) United States
(12) Patent Application Publication
(10) Pub. No.: US 2016/0120009 A1
(43) Pub. Date: Apr. 28, 2016

(54) DEVICE WITH A GRAPHICAL USER INTERFACE FOR CONTROLLING LIGHTING PROPERTIES

(71) Applicant: KONINKLIJKE PHILIPS N.V., Eindhoven (NL)

(72) Inventors: DZMITRY VIKTOROVICH ALIAKSEYEU, EINDHOVEN (NL); JONATHAN DAVID MASON, WAALRE (NL); BERENT WILLEM MEERBEEK, EINDHOVEN (NL); PHILIP STEVEN NEWTON, WAALRE (NL)

(73) Assignee: KONINKLIJKE PHILIPS N.V., EINDHOVEN (NL)

(21) Appl. No.: 14/890,953

(22) PCT Filed: May 5, 2014
(86) PCT No.: PCT/IB2014/061193

§ 371 Date: Nov. 13, 2015

(30) Foreign Application Priority Data
May 13, 2013 (EP) 13167414.5

(51) Int. Cl. H05B 37/02; G06F 3/0481; H04N 5/232; G06F 3/0484

(52) U.S. Cl. CPC H05B 37/0245; G06F 3/04847; G06F 3/0481; H04N 5/23293; G06F 3/04842

(57) ABSTRACT

The invention provides a device comprising a screen for displaying a graphical user interface, wherein the device is configured to control a lighting property of a lighting unit of a plurality of lighting units, wherein the device is configured to display on a screen of the device a plurality of lighting-related user interface elements, wherein each lighting-related user interface element includes a photograph-based picture of the corresponding lighting unit in its application environment, wherein each lighting-related user interface element is configured to control the lighting unit light of the corresponding lighting unit, and wherein each lighting-related user interface element is configured to show a lighting effect corresponding to the lighting property of the corresponding lighting unit.

### FIELD OF THE INVENTION

The invention relates to a device with a graphical user interface (GUI) configured to control a lighting property of a lighting unit. The invention further relates to a method of controlling a lighting property of a lighting unit. The invention also relates to a computer program enabled to carry out such a method, as well as to a data carrier storing such a computer program. Further, the invention also relates to a lighting system.

### BACKGROUND OF THE INVENTION

Several methods are known in the art for controlling lighting devices in spaces. U.S. Pat. No. 6,611,297, for instance, describes an illumination control method, wherein illumination of an appreciation space is controlled in association with an image displayed on an image display device so that a realism of the image displayed on a screen of the image display device can be enhanced, where an appreciator appreciating the image is in the appreciation space. U.S. Pat. No. 6,611,297 further describes that one or more light sources provided in the appreciation space are controlled so that at least one parameter of a level, a light color, a luminous intensity distribution, and a direction of illumination to the appreciation space is made substantially coincident with a corresponding parameter of a virtual image space imaginarily created from the image displayed on the image display device.

### SUMMARY OF THE INVENTION

It is a desire to produce a new type of (LED) lamp that could e.g. be connected and controlled via a local network and/or the internet. This enables people to control all their lighting from a single device such as a Smartphone or tablet PC. In addition to being connected, these advanced (LED) lamps can be capable of producing different light effects such as tunable white and/or colored light, which creates many application possibilities for these lamps. This the reason why for many applications the light switch will need to be replaced by novel forms of interaction that offer richer interaction possibilities such as multi-touch mobile devices.

The conventional physical light switch has one-to-one mapping to the luminaire. This will not be the case for mobile Apps since, in principle, they enable a user to control many luminaries from a single application and, sometimes, at a distance (i.e. while physically being in a different location). It therefore appears to be important to support user awareness of which lamps are currently being controlled and in what state they are as well as to make it easy for the user to identify a particular luminaire in the application. Possible solutions for luminaire identification are e.g. creating unique names, assigning icons, or using a written indication for the type of luminaire. Further, grouping based on location or state of the luminaire can be given in textual or graphical form.

When people use a Smartphone or a tablet etc. to interact with their lighting devices/luminaires, e.g. to adjust a light setting, they will have to identify which luminaire they need to adjust. They look for a label or tag on the devices that identify the luminaire of interest. Due to unclear or ambiguous naming or labeling, the only way to verify whether they have selected the correct luminaire is by altering the light output and check the changes in light output.

Hence, it is an aspect of the invention to provide an alternative user control, especially a (portable) device including such a user control, which preferably further at least partly obviates one or more of the above-described drawbacks. Likewise, it is an aspect of the invention to provide an alternative method of controlling one or more lighting properties, which preferably further at least partly obviates one or more of the above-described drawbacks. Further aspects of the invention relate to a computer program enabled to carry out such a method as well as a record carrier for storing such a computer program, and to the use of the device described herein for controlling one or more lighting properties.

The above-mentioned problems are addressed by this invention. In this invention, a unique combination of luminaire representation using a photograph (which luminaire is herein further also indicated as “lighting unit”) and a graphical representation of the light effect currently created by this luminaire is proposed. This invention provides the end user with a means of identifying the luminaire and its current state via a picture (which they may have taken using a camera on their mobile device) and by the light output in a visual and graphical form. The user can e.g. take a picture of the luminaire, e.g. in their home or in an office or in a shop, etc. Optionally, the lighting system can determine from this picture which luminaire it is (for example by linking to and using the IP for the coded light technology). This can for instance be done when the luminaire or lighting unit includes a label that can be recognized by software when analyzing the picture. Alternatively or additionally, the lighting unit includes address information in the light, which might be recognized by a mobile device. However, assigning the lighting unit may also be done by training the software to recognize the lighting unit. For instance, a first picture of a first lighting unit may be linked to such a lighting unit when only the first lighting unit is switched on; a second picture of a second lighting unit may be linked to such a lighting unit when only the second lighting unit is switched on, etc. etc. This image is assigned to the control of that luminaire. When the user wants to control or alter the light from a particular luminaire, the user only needs to select the image of the luminaire which the user wishes to adjust. Other solutions for identifying lamps/luminaires might include a degree of abstraction such as assigning a number or an icon which the user must remember (see also above). However, this invention removes this cumbersome aspect.

Advantageously, for instance for further assistance of the user, the invention may also include embodiments wherein e.g. when the user turns on the luminaire and/or adjusts the light parameters, the area behind the image (/icon/photograph-based picture) may glow at the corresponding setting, or another (corresponding) lighting effect occurs. Once set, the effect or simulated glow behind the image may remain; thus, the user does not need to look from the device to the room repeatedly to check if he has selected the correct image. Hence, this invention may provide the user with double feedback (such as image and glow) to ease the use of such luminaires. Additionally, instead of just an effect or glow behind the picture, the look of the luminaire on the picture can be altered to reflect its current state.

Hence, in a first aspect, the invention provides a (portable) device (herein further also indicated as “device”) comprising a screen for displaying a graphical user interface (GUI or graphical UI), wherein the device is configured to control a lighting property of a lighting unit of a plurality of lighting units (wherein the plurality of lighting units are configured to be controllable by the device), wherein the device is configured to display (at least temporarily) a plurality of lighting-related user interface elements (or lighting-related graphical user interface elements) on the screen of the device, wherein each lighting-related user interface element includes (an icon comprising) a photograph-based picture of the corresponding lighting unit in an application environment (wherein the corresponding lighting unit is configured), wherein each lighting-related user interface element is configured to control the lighting unit light of the corresponding lighting unit, and wherein each lighting-related user interface element is configured to show a lighting effect corresponding to the lighting property of the corresponding lighting unit.

In a further aspect, the invention also provides a method of controlling a lighting property of a lighting unit of a plurality of lighting units, the method comprising selecting one of the lighting units by choosing the corresponding lighting-related user interface element and changing a property of the lighting unit light from a first to a second state, and wherein the lighting effect of the corresponding lighting-related user interface element changes from a first state to a second state corresponding to the change from the first to the second state of the property of the lighting unit light of the lighting unit. In such a method, especially the (portable) device as described herein may be applied.

In yet a further aspect, the invention provides a lighting system comprising a plurality of lighting units and one or more control units, wherein the one or more control units are configured to control a lighting property of a lighting unit of the plurality of lighting units, wherein the one or more control units are configured to be controlled via a (portable) device such as described herein, such a device especially comprising a screen for displaying a graphical user interface, wherein the device is configured to control a lighting property of a lighting unit of the plurality of lighting units, wherein the device is configured to display a plurality of lighting-related user interface elements on a screen of the device (at least temporarily), wherein each lighting-related user interface element includes (an icon comprising) a photograph-based picture of the corresponding lighting unit in an application environment, wherein each lighting-related user interface element is configured to control the lighting unit light of the corresponding lighting unit, and wherein each lighting-related user interface element is configured to show a lighting effect corresponding to the lighting property of the corresponding lighting unit.

Advantageously, in this way a user can easily choose the lighting unit whose lighting property or properties have to be changed, and change one or more of these properties. Due to the visualization of the lighting unit (on the screen of the device), which may be a realistic reproduction of the lighting unit in its application environment, the user can immediately recognize the target lighting unit and choose the desired lighting properties for the target lighting unit. This appears to be much easier than the use of abstract icons, numbers, names, or even lighting units with a neutral background (i.e. not in their application environment, as may be the case for instance in a sales brochure). Especially this may be the case when there are a plurality of (similar or even identical) lighting units, i.e. two or more lighting units, especially when there is a large number of (similar or even identical) lighting units, such as four or more lighting units, such as eight or more lighting units, especially 20 or more lighting units. Also see further below.

Herein, the device is especially indicated as “portable” device. Hence, this device may particularly not be a desktop computer or a fixed (lighting) control system (such as integrated in or connected to a wall), such as in general a (lighting) control system of a hospitality area or office. Especially, the device may be selected from the group consisting of a cell phone, a personal digital assistant (PDA), a Smartphone, a tablet, an ultrabook, a laptop, and a device integrated into what a user is wearing. As indicated above, the device particularly is a portable device selected from the group consisting of a cell phone, a personal digital assistant (PDA), a Smartphone, a tablet, an ultrabook, a laptop, and a device integrated into what a person is wearing. Herein, the “device integrated into what a person is wearing” may e.g. relate to a device integrated in a watch or in a pair of glasses or other augmented eyewear, such as the “Google glass” or the Sony equivalent, as e.g. described inter alia in U.S. Pat. No. 7,631,968 and US2013/0069850, respectively. Optionally, the device integrated into what a person is wearing may also relate to a device integrated in clothes. Hence, the (portable) device may especially be selected from a handheld device, such as a Smartphone, a device integrated in clothing, a device being part of a fashion accessory, or a head-mounted display (HMD) device. The device is an electronic device. In general, the weight of the device is below 1.5 kg.

The graphical user interface is especially a type of user interface that allows a user to interact with the electronic device by means of one or more images. The screen of the device may be comprised by the graphical user interface. The user may give commands through the screen. Especially, the screen (graphical user interface) is of the touch screen-type. Hence, the user can control the touch screen through simple or multi-touch gestures by touching the screen with one or more fingers. Hence, the device, and especially the GUI, may comprise a touch screen. Some touch screens can also detect objects such as a stylus or ordinary or specially coated gloves. The touch screen enables the user to interact directly with what is being displayed. Alternatively or additionally, the graphical user interface may be configured to allow one or more of eye control and voice control. Hence, in such embodiment(s), the user may control the device, i.e. the lighting unit(s), via one or more of eye control and voice control, respectively.

The device, or more particularly its graphical user interface, is especially configured to control a lighting property, i.e. a lighting property of lighting unit light (of one or more lighting units). The term “a lighting property” may also relate to one or more lighting properties, such as a plurality of lighting properties. The term “lighting unit light” refers to the light (that can be) generated by the lighting unit(s). This lighting unit light may have lighting properties such as color, intensity, saturation, tint, shade, tone, color point, color temperature, spectral light distribution. Especially, the one or more lighting properties may at least be selected from intensity, saturation and color. However, the lighting properties may also include one or more properties selected from the group consisting of beam shape, beam direction and beam color distribution (as the color distribution within a beam may optionally also be uneven). By controlling e.g. the beam shape and/or the beam direction, one may for instance also split a beam into multiple beams. For instance, (controllable) optics may be applied to provide a plurality of beams. Further, the lighting properties may include time-dependent properties, such as one or more of a dynamic lighting property and a lighting menu. An example of the former is a light that switches on and off with a predetermined frequency and an example of the latter may for instance be a lighting menu like “working day” or “sunset”, wherein the selection of such a menu causes the lighting unit to provide light that may for instance assist with working during daytime or taking rest during evening hours, respectively. Another example of a dynamic lighting property may be e.g. a (slow) transition from a first color, such as red, to a second color, such as blue, etc. However, all kinds of lighting menus may be possible. Further, the lighting property might also be a biological lighting property, such as light that promotes alertness or light that promotes relaxation of a human (or an animal), see for instance also WO 2008/146220. Hence, especially, the lighting properties of lighting unit light may be selected from the group consisting of intensity, saturation, color, beam shape, beam direction, beam color distribution, a dynamic lighting property, a biological lighting property, and a lighting menu. Hence, in specific embodiments, the device is further configured to control a lighting property selected from the group consisting of intensity, saturation, color, beam shape, beam direction, beam color distribution, a dynamic lighting property, a biological lighting property, and a lighting menu. However, other options may also be possible. The lighting unit(s) that is (are) controllable by means of the device may thus include one or more lighting properties that are controllable, such as e.g. at least one or more of intensity, saturation and color, especially also at least one or more of beam shape, beam direction and beam color distribution, and especially also one or more of a dynamic lighting property, a biological lighting property, and a lighting menu. However, other options may also be possible.

Control of the lighting unit light may include, in an embodiment, direct control, i.e. that the device communicates with the lighting unit directly. However, in another embodiment, control may take place via a (central) control unit, which in turn communicates with the lighting unit(s). Hence, the lighting unit(s) is (are) configured to be controllable by the device. In other words, the lighting unit(s) is (are) configured to be controllable by an external device, such as a (central) control unit, which in turn may be configured to be controlled by a remote control, such as the (portable) device described herein.

As indicated above, the device is particularly configured to display on a screen of the device a lighting-related user interface element (at least temporarily), even more particularly to display a plurality of lighting-related user interface elements. For instance, there may be one lighting-related user interface element which, when chosen by the user, opens a window with a plurality of lighting-related user interface elements. The lighting-related user interface element at least comprises (an icon comprising) a photograph-based picture of the lighting unit (of which one or more lighting properties may be controllable by means of the device). Hence, each lighting-related user interface element is configured to control the lighting unit light of the corresponding lighting unit. When there are a plurality of lighting units, the corresponding lighting-related user interface elements may all be shown on the screen of the device (at least temporarily), or a limited number of the lighting-related user interface elements may be shown. Subsets of the lighting-related user interface elements may be shown on the screen. In yet another embodiment, the plurality of lighting-related user interface elements can be shown consecutively. With finger movements, or other commands, the user may choose one or more lighting-related user interface elements at the same time or consecutively.

As indicated above, this photograph-based picture shows the lighting unit in its application environment (see also below). An advantage thereof is that the user may easily recognize the lighting unit which may be the target of a decision to alter the lighting property or properties. The application environment is especially a space (including a plurality of spaces) wherein the lighting units are arranged, i.e. a functional arrangement in such a space (see also below).

The term lighting unit refers to a unit that is configured to provide light. This may be any type of light, including one or more of sphere lighting, target lighting, wall washing, etc. etc. Sphere lighting may also be indicated as omnidirectional lighting. Further, target lighting may also be indicated as spot lighting. The lighting unit may comprise one or more light sources. The one or more light sources may be selected from the group comprising incandescent lamps, fluorescent lamps, high pressure lamps, semiconductor light sources (such as light emitting diodes (LEDs) or laser diodes, etc. Especially, the one or more light sources comprise solid state light sources such as solid state LEDs. Although there may be more than one light source, in general—herein—the lighting unit is configured to function as a unit and the lighting properties of the light of the lighting unit are controlled.

In a specific embodiment, the light source comprises a solid state LED light source (such as a LED or laser diode). The term “light source” may also relate to a plurality of light sources, such as 2-20 (solid state) LED light sources. Hence, the term LED may also refer to a plurality of LEDs. The lighting unit may comprise a plurality of light sources. For instance, the lighting unit may comprise a plurality of (solid state) LEDs, such as ≧10 LEDs, like 20-2500 (solid state) LEDs. Especially, the lighting unit may be configured to provide at least white light, although other colors are not excluded.

Further, the (device and method, etc., of the) invention is particularly applied in the context of a plurality of light sources, as in such a context the recognition of a plurality of lighting units might be desirable for a user. The plurality of lighting units are (thus) also especially configured to be controllable by the device. This does not exclude that in a space also other lighting units may be available that are not controllable by the device (or method).

As indicated above, the photograph-based picture is of the corresponding lighting unit in its application environment. Hence, to provide the (icon comprising the) photograph-based picture, at least one picture (or a plurality of pictures, see also below) was taken and configured into the photograph-based picture. The photograph-based picture may thus show a plurality of light sources of a single lighting unit, in case the lighting unit comprises a plurality of light sources. In general, however, the photograph-based picture will substantially only show a single lighting unit, or at least part of a single lighting unit (in its application environment). However, it cannot be excluded that in the stage of making the photograph of the lighting unit, also one or more other lighting units might be captured as well. Especially, however, the photograph-based picture shows predominantly a single lighting unit, or at least part of a single lighting unit (in its application environment). Image cropping or image framing may (further) be applied to select a single lighting unit, if desired. The photograph-based picture can be used as icon. Hence, especially, the photograph-based picture is configured as icon. The lighting-related user interface elements include such a photograph-based picture (or icon comprising a photograph-based picture).

In an embodiment, wherein at least part of a further lighting unit would be displayed in the photograph-based picture, the display surface area of the photograph-based picture showing the predominant lighting unit is equal to or larger than the display surface of the photograph-based picture that shows (partly) one or more other lighting units. Further, in general, the display surface area of the photograph-based picture showing the lighting unit is at least 5% of the entire display surface area of the photograph-based picture, such as in the range of 10-50%. In general, a substantial part of the lighting unit will be displayed, although optionally only part is displayed. For instance, for a lighting unit including a large stand, it is not necessary to display the entire stand, as e.g. the light emitting part of the lighting unit against the background of a wall is already enough to provide a photograph-based picture that can be recognized by a user. Hence, the photograph-based picture does not necessarily display the entire lighting unit; it may also display part thereof. The other part of the display surface area of the photograph-based picture is occupied particularly by the application environment.

The term “application environment” refers to the environment surrounding the lighting unit when the lighting unit is installed (in a space, see below), for instance arranged on a table, on a floor, to a wall, to a ceiling, etc. etc. The other part of the entire display surface area of the photograph-based picture not occupied by the (target) lighting unit may thus include at least a part of furniture, a wall, a floor, a ceiling, a piece of art, etc. etc. Therefore, in an embodiment, the photograph-based picture is configured to show more than one light source of a single lighting unit, and that image enables to control the more than one light source. Especially, the image will also re-render the more than one light source and the UI means and manipulation of the image will control the lamps in the picture.

Due to the use of the photograph-based picture, a realistic display of the lighting unit in its application environment is shown on the photograph-based picture. However, this does not exclude that the picture that is displayed is the result of some rendering, editing or optimization, and thus may deviate from the original picture. However, the photograph-based picture is not an abstract picture of the lighting unit. Further, the picture may (also) be rendered during use in order to reflect the lighting property/properties (see also below).

In embodiments, the picture of the lighting unit might have been taken with the device itself. However, in other embodiments the picture of the lighting unit that formed the basis of the photograph-based picture might have been taken with another device, like a digital camera or a webcam or (another) Smartphone. In the former embodiments, the device as described herein may further comprise a camera, wherein the (portable) device may further also be configured to convert a photograph captured with the camera into a photograph-based picture (for an icon)(especially for use in a lighting-related user interface element). Optionally, the camera that is used and/or the device including such a camera, may be configured to retrieve depth information from such a picture. Note that, in embodiments, the term “picture” may also relate to a plurality of pictures (see also below). Optionally, a camera is used and/or the device including such a camera is used (to capture the picture) that is configured to allow stereopsis (i.e. the impression of depth that is perceived when a scene is viewed with both eyes by someone with normal binocular vision). This may for instance be used for 3D rendering of the photograph-based picture.

As indicated above, not only one picture, but also a plurality of pictures, may be captured from the lighting unit. Such a plurality of pictures, including e.g. a movie, or pictures taken with a camera in high speed mode, may for instance be used to get 3D information of the lighting unit in its application environment. This may for instance allow perceiving the lighting unit in the photograph-based picture from different views. Alternatively or additionally, the plurality of pictures may be captured from the lighting unit while the lighting unit is showing different states of the lighting unit light (respectively). In this way, pictures may be captured of the lighting unit (in its application environment) showing different (available) lighting properties. This may be used to render the photograph-based picture in the photograph-based picture as a function of the (actual or desired) lighting property/properties.

Further, in an embodiment, each lighting-related user interface element is configured to show a lighting effect corresponding to the lighting property (such as one or more lighting properties of the lighting unit light) of the corresponding lighting unit. In general, the device may be configured to include, and/or the method may include, at least the option that the lighting-related user interface element shows a lighting effect corresponding to the present lighting unit light. For instance, when the lighting unit is switched off, there may be no glow around the corresponding photograph-based picture (corresponding icon), or there may be a blinking glow indicating that the respective lighting unit can be switched off. When the lighting unit provides warm white light, there may for instance be a yellowish glow around the photograph-based picture. Further possible lighting effects are indicated below. However, additionally, the device may be configured to include, and/or the method may include, also the option that the lighting-related user interface element shows a possible lighting effect corresponding to a possible lighting property.

In an embodiment, the lighting-related user interface element may comprise a widget, or optionally may be a widget, wherein the widget is (further) configured to provide a menu-like option for controlling one or more lighting properties. For instance, control of a lighting property of the lighting unit may take place by selecting the picture representing the lighting unit which brings up a screen with a glowing circle. Increasing the size of the circle through a swiping gesture will increase the light output (lumens) of the lamp. Decreasing the size of the circle, on the other hand, will decrease the light output. In some LED lighting systems, the color temperature can be controlled independently. If such a lamp is installed in the lighting unit, the user can alter the color temperature by rotating the circle. Alternatively, a secondary lighting-related user interface element (e.g. pop-up menu, widget) might appear on selecting an image/luminaire, which interface element allows the user to change the lighting property. This lighting-related user interface element may only show the options/light parameters that can be altered for that particular luminaire. Hence, in an embodiment, each lighting-related user interface element comprises a widget with a graphical element configured to control at least one of the lighting properties of the lighting unit light, and wherein the graphic element has one or more abilities, for example selected from the group consisting of: being scalable in size, being rotatable, being draggable, and being scrollable. Other options may however also be possible. Hence, in embodiments, the lighting-related user interface element can be such a widget or the widget pops up when the lighting-related user interface element is selected. Further, this may include the situation where the photograph-based picture itself is the input for a touch gesture. Hence, in such an embodiment there may not be any visible lighting-related widgets, only the photograph-based picture(s) of (a) lighting unit(s). For instance, this may thus (also) include embodiments wherein the device is configured to include embodiments, and/or the method may include embodiments, wherein when the user performs a gesture on (or over) this photograph-based picture, a particular lighting parameter of the luminaire is controlled.

The lighting effect corresponding to the lighting property may for instance include a glow around at least part of the photograph-based picture. The color of the glow and/or the intensity of the glow may correspond to the color and/or intensity of the lighting unit light. The term “corresponding” in this context may especially indicate that there may be a (visual) similarity and, to a certain extent, a similar scalability. For instance, when increasing the intensity of the lighting unit light, the intensity of the glow may increase, etc. In an embodiment, the position of the glow around the photograph-based picture may also represent the state of the light. For instance, if the glow is around the bottom of the photograph-based picture only, this may represent a low light level, and the higher and fuller it is, the brighter the lighting unit light is. Therefore, in embodiments, the device is configured to provide a glow around at least part of the photograph-based picture as a lighting effect. Likewise, the method may further comprise providing a glow around at least part of the photograph-based picture as a lighting effect and rendering the glow as a function of the actual lighting property of the corresponding lighting unit. Hence, when e.g. dynamic lighting unit light effects are implemented, the glow (around the photograph-based picture or around the icon comprising the photograph-based picture) and the rendering may also show the dynamics and move in time with the real lights or show a representative dynamic. The photograph-based picture may in principle have any shape (and any possible size), for instance a round, a square, or a rectangular shape, etc.

Other embodiments which may optionally also be combined with the above, lighting effect corresponding to the lighting property may for instance include a rendering of the photograph-based picture. For instance, the color of the light and/or the intensity of the light provided by the lighting unit shown on the photograph-based picture may correspond to the color and/or intensity of the lighting unit light. To achieve such effect, use may for instance be made of the above mentioned plurality of pictures of the lighting unit, while the lighting unit is showing different states of the lighting unit light (respectively). This plurality of pictures may be used to render the photograph-based picture in the photograph-based picture as a function of the (actual or desired) lighting property/properties. Alternatively or additionally, software may be used to animate the properties of the lighting unit light on the photograph-based picture.

Hence, in embodiments, the device may further comprise a processor configured to render the photograph-based picture as a function of the actual lighting property of the corresponding lighting unit. Likewise, in embodiments, the method may further include rendering the photograph-based picture as a function of the actual lighting property of the corresponding lighting unit. For instance, such processes may be applied for processing the pictures, image rendering, etc. The processor and the screen may especially allow the graphical user interface functionality as described herein.

However, alternatively or additionally, an external processor (of an (external) control unit) may be used for at least partly performing one or more such actions. For instance, a server may be applied. Particularly, the photographic rendering of the light effect to update the lighting-related UI element may require intensive processing power and be suitable for processing at a server site, not in the smartphone or tablet or other type of device. Whether or not a remote processor is used may for instance also depend upon the quality of rendering desired. A “simple” glow effect around the photograph-based picture may for instance be readily achieved using a portable device such as a smart phone, whereas a rendering of the photograph-based picture on the photograph-based picture to correspond with a different light status may be performed remote from the device by means of a more powerful processor, such as by assistance from the cloud.

The device may include an option that the lighting unit couples back the status of the lighting unit light property. This may be a direct communication between the lighting unit and the device. However, in another embodiment, the feedback may be via a (central) control unit, which in turn communicates with the device. Where applicable, communication between the lighting unit and the (central) control unit, between the lighting unit and the device, between the (central) control unit and the device, may be wireless communication (internet and/or (local) network). Communication between the lighting unit and the (central) control unit might be executed via wired connections. Optionally, communication from the lighting unit to the device may be executed via DALI (Digital Addressable Lighting Interface) or other communication protocols, such as DMX (Digital MulitpleXed), in case the device has a sensor configured to detect such communication. Alternatively or additionally, also Zigbee, WiFi, bluetooth, coded light may be applied. Based on this feedback, the device may render the photograph-based picture and/or the lighting effect.

In specific aspects, the invention also provides the use of the device as defined herein, or the use of the method as defined herein, for controlling a lighting property of a lighting unit of a plurality of lighting units in a space. The space may for instance be a shop, an (indoor) workplace, or a house. However, the space may also be a factory, a plant, a shopping mall, a hospitality area, like a hospital, a nursery home, etc. Hence, the term “space” used herein may relate to a shop, a shopping mall, a department store, an office (especially with a plurality of rooms), a factory, a plant, a house, a hospitality area, such as a restaurant, a hotel, a hostel, a motel, a restaurant, a bar, a pub, a public house, a hospital, a nursery home, a home, a car, an (indoor) workplace, and an office etc. Especially, the space is selected from the group consisting of a factory, a plant, a shopping mall, a hospitality area, a shop, a shopping mall, a department store, a home, a car, and an office. The lighting device may be part of or may be applied in e.g. office lighting systems, household application systems, shop lighting systems, home lighting systems, accent lighting systems, spot lighting systems, theater lighting systems, fiber-optics application systems, warning sign systems, medical lighting application systems, indicator sign systems, decorative lighting systems, portable systems, automotive applications, green house lighting systems, horticulture lighting, etc. Within such a space, the lighting system as described above may be applied.

The invention may further include a calibration for one or more of (a) allowing the device to learn the plurality of lighting units in the space, including capturing photographs of each lighting unit and attributing photographs to lighting-related user interface elements, and (b) learning the lighting properties of each lighting unit. The former embodiment may for instance include capturing a plurality of pictures from the lighting unit while the lighting unit is showing different states of the lighting unit light (respectively) (see also above). This may be used to render the photograph-based picture in the photograph-based picture as a function of the (actual or desired) lighting property/properties. Especially, such calibration may be performed once, after which the device knows the lighting devices in the space and can control them and render the photograph-based pictures and/or the lighting effect.

In a further aspect, the invention also provides a computer program enabled to carry out the method as described herein and/or a record carrier storing such a computer program.

In a further aspect, the invention provides a (portable) device comprising a screen for displaying a graphical user interface, wherein the device is configured to control a lighting property of a lighting unit (wherein the lighting unit is configured to be controllable by the device), wherein the device is configured to display on the screen of the device (at least temporarily) a lighting-related user interface element, wherein the lighting-related user interface element includes (an icon comprising) a photograph-based picture of the corresponding lighting unit in an application environment, wherein the lighting-related user interface element is configured to control the lighting unit light of the corresponding lighting unit, and wherein the lighting-related user interface element is configured to show a lighting effect corresponding to the lighting property of the corresponding lighting unit. In a further aspect, the invention also provides a method of controlling a lighting property of a lighting unit, the method comprising selecting the lighting unit by choosing the corresponding lighting-related user interface element and changing, by means of the lighting-related user interface element, a property of the lighting unit light from a first to a second state, and wherein the lighting effect of the corresponding lighting-related user interface element changes from a first state to a second state corresponding to the change from the first to the second state of the property of the lighting unit light of the lighting unit.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adverb substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may, in an embodiment, refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-b schematically depict an embodiment of the device;

FIGS. 2a-2b schematically depict some aspects of the invention;

FIGS. 3a-3d schematically depict some aspects of—amongst others—the method of the invention;

FIGS. 4a-4b schematically depict some further aspects of the invention. The drawings are not necessarily to scale

### DETAILED DESCRIPTION OF THE EMBODIMENTS

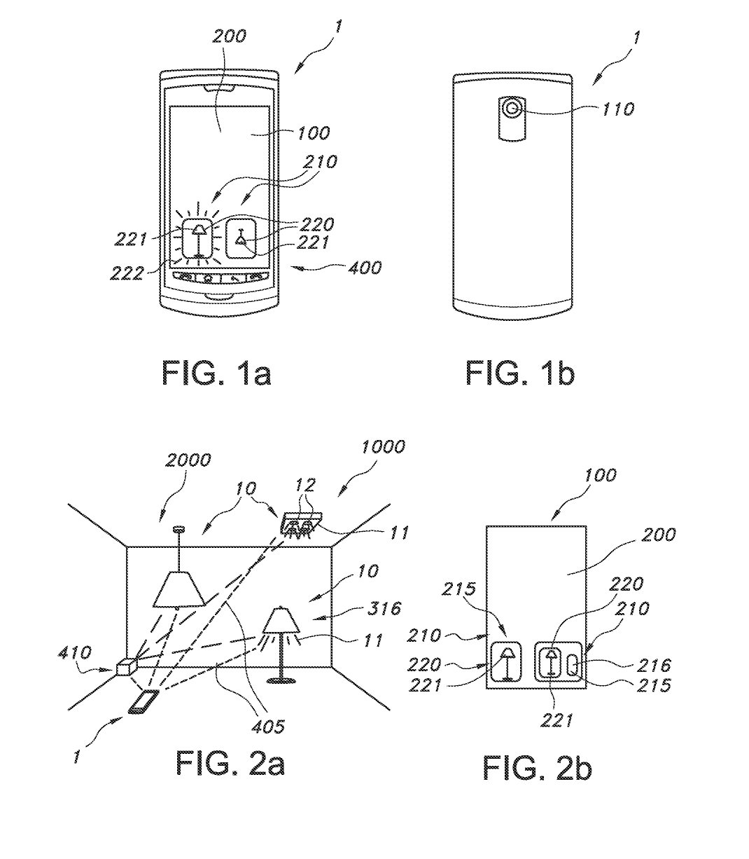

FIG. 1a schematically depicts an embodiment of portable device 1 comprising a screen for displaying a graphical user interface, wherein the device 100 is configured to control one or more lighting properties (of lighting unit light 11) of a lighting unit (of a plurality of lighting units). The device 1 is configured to display on a screen 200 of the device 1 a plurality of lighting-related (graphical) user interface elements (here by way of example only two), wherein each lighting-related user interface element 210 includes a photograph-based picture 221 (the schematic drawings of the lighting units, see also below) of the corresponding lighting unit in its application environment. As indicated above, the lighting-related user interface element 210 may thus include an icon 220 comprising such a photograph-based picture 221. Each lighting-related user interface element 210 is configured to control the lighting unit light of the corresponding lighting unit. Further, each lighting-related user interface element 210 is configured to show a lighting effect 222 (schematically shown on the left by means of the light around the lighting-related user interface element 210) corresponding to the lighting property of the corresponding lighting unit. Reference 400 schematically indicates the presence of a processor (especially within the device 1). Such a processor 400 may be configured to render the photograph-based picture 221 as a function of the actual lighting property of the corresponding lighting unit. FIG. 1b schematically depicts that the device 1 may also include a camera 110, which may for instance be used to capture a picture from a lighting unit in its application environment, which picture may then be converted to the photograph-based picture 221 (for the icon 220 (see also below)).

FIG. 2a schematically depicts a space 1000, such as a room in a house, with two hanging lighting units 10 and a standing lighting unit 10. One of the hanging lighting units 10 comprises a plurality of light sources 12. Light, i.e. lighting unit light, provided by the respective light sources is indicated with reference 11. Further, a device 1, such as a Smartphone, is schematically depicted. The device 1, such as the Smartphone, can control the lighting units 10 directly and/or via a control unit 410 (which is indicated to be in the room only by way of example, but which may also be located elsewhere, outside the room). Communication between devices is indicated with dashed lines. Different streams may be possible, either directly or via the control unit 410, dependent upon the type chosen. A plurality of lighting units 10 are configured to be controllable by the device 1. Here, by way of example, all lighting units 10 are controllable, but also other lighting units may be available.

FIG. 2a also schematically depicts a lighting system 2000 comprising a plurality of lighting units 10 and one or more control units 410, wherein the one or more control units 410 are configured to control one or more lighting properties (of lighting unit light 11) of the lighting units 10. As indicated above, the one or more control units 410 are configured to be controlled via a portable device 1 comprising a screen for displaying a graphical user interface, wherein the device 100 is configured to control one or more lighting properties (of lighting unit light 11) of a lighting unit 10 of a plurality of lighting units 10. Further, the device 1 is configured to display a plurality of lighting-related user interface elements 210 (see also above) on a screen 200 of the device 1. This may e.g. be part of a submenu that opens when an icon with a photograph-based picture or widget is activated.

FIG. 2b schematically depicts the graphical user interface 100 and screen 200. By way of example, two lighting-related user interface elements 210 are shown. The left one may be a widget itself, whereas the right one may include a widget. Widgets are indicated by means of references 215. These may be used to control the lighting unit light. For instance, by pressing on the left icon 220, the intensity may be increased, and after a maximum, the intensity of the lighting unit light may be decreased again, etc. In the example on the right, the widget may be e.g. a graphic element that can be dragged up and down to respectively increase and decrease for example the intensity, color temperature, etc. Alternatively, the widget 215 may open a menu, wherein the properties of the lighting unit light may be controlled. Controlling can be done with graphical controlling options known in the art, of which some dedicated examples are shown in FIGS. 4a-4b.

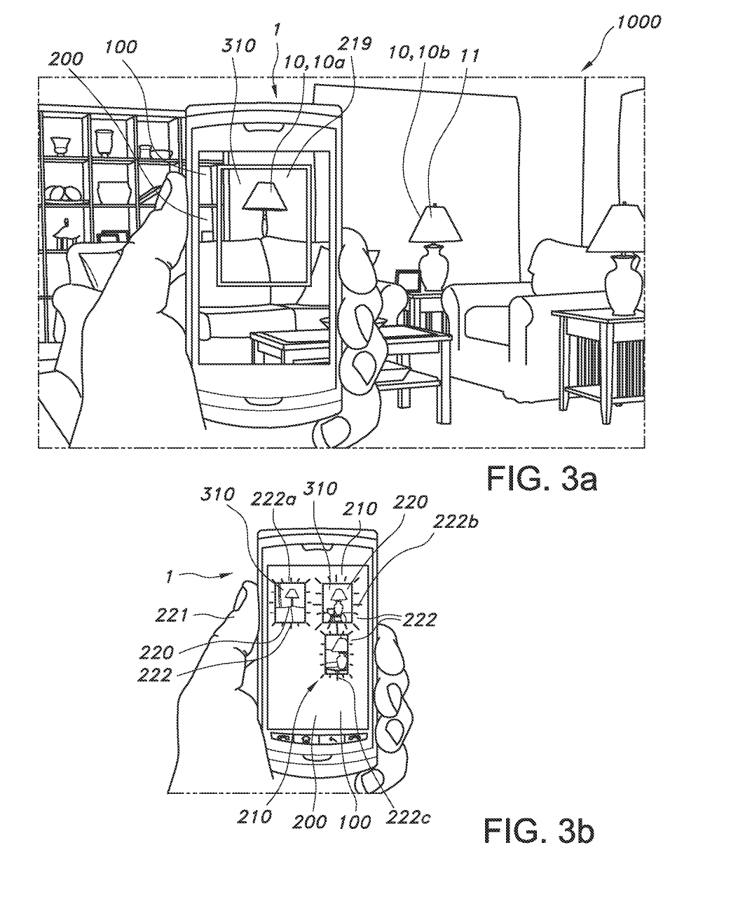

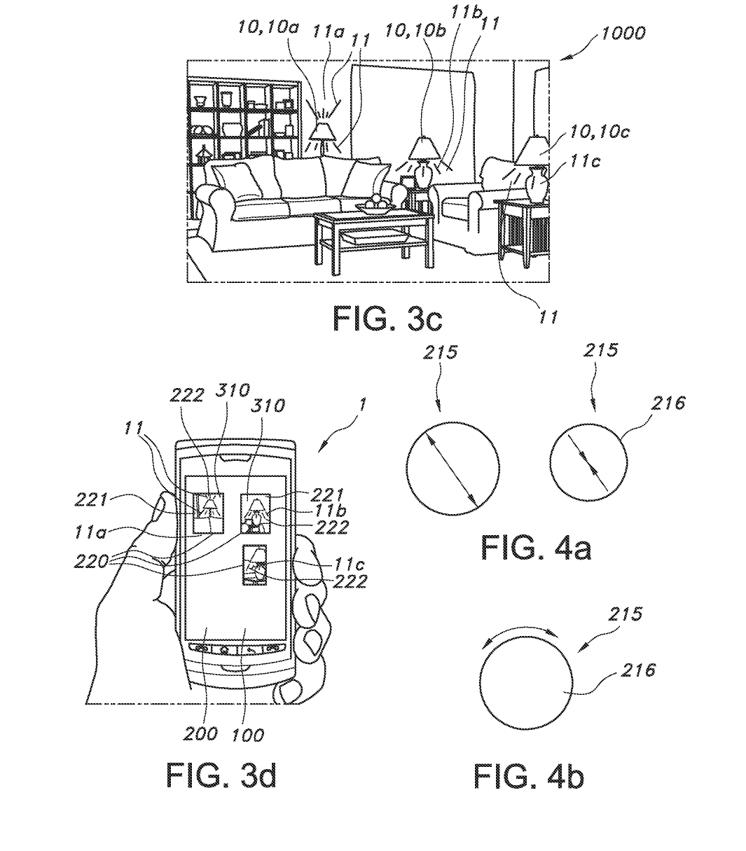

FIG. 3a schematically shows that, using e.g. the device 1, a picture 219 can be taken of a lighting unit 10 in its application environment 310 (in a space 1000). This picture 210 can be used as basis for an icon for controlling the respective lighting units 10. As schematically shown in FIGS. 3b and 3c, when the user wants to select a lighting unit 10 to alter the output of such a lighting unit, he can use the image (icon) and the glow (effect 222) in the background to help identify the lighting unit 10. The context information in the image of the lighting unit 10 (e.g. above the dinner table, and to the right of the couch) might already be sufficient for the user to identify the 1 lighting unit 10, but it can be augmented with the glow to make it even easier. The glow behind the (static) image can represent the parameters of the (actual) light output. If there is no glow or (e.g.) a black line, then the lighting unit 10 is switched off. If the light is on at high intensity, a very bright glow may appear on the screen. If the light output is colored then this too is shown by the color of the glow. The glow may also represent other parameters, including dynamic effects, direction, beam width, saturation, and color temperature. In order to distinguish between the lighting units 10, the lighting unit light 11, and the lighting effects 222 on the screen, these are further also indicated with references 10a-10c, 11a-11c, and 222a-222c, respectively. When selecting and controlling luminaires remotely, the (end) user will be able to see instantly the type of light he will get, without being in the room and without having to navigate through to other screens or graphical layers.

FIG. 3d schematically depicts a further embodiment. This embodiment is similar to the embodiment above, with a difference in how the state of the lighting unit 10 is displayed. Instead of the back glow, the image of the lighting unit 10 itself is altered to display the state of the luminaire; see FIG. 3d (by way of example). This effect can be achieved using simple image processing. For instance, when the user takes the picture of the lighting unit 10 for the first time, instead of one sample (photo), several quick consecutive shots are made; the timing of the shots is made to correspond with changes in the light effect. After that, when the user controls the lighting unit 10 instead of the glow around the picture, the look of the lighting unit 10 itself is altered to reflect its current state. The alteration can be done using the sample pictures and a simple image processing algorithm.

Additionally, the shape and size of the various images of the lamps/luminaires can also provide a visual indicator of their state. For example, lamp A may be brighter than lamp B and thus the image representing lamp A would be proportionally larger than the image depicting lamp B so as to represent this difference in light output.

The controlling of the light effect from the lamp may be done by selecting the picture representing the lighting unit 10 which brings up—by way of example—a screen with a glowing circle. Increasing the size of the circle through a swiping gesture will increase the light output (lumens) from the lighting unit 10, while decreasing the size will decrease the light output. This is illustrated in the schematic drawing 4a. In some LED lighting systems the color temperature can be controlled independently. If such a lighting unit 10 is installed in the luminaire, the user can alter the color temperature by—by way of example—rotating the circle, see the schematic drawing 4b. Alternatively, a secondary user interface element (e.g. pop-up menu, widget) might appear on selecting an image/lighting unit 10 that allows the user to change the light effect. This interface element only shows the options/light parameters that can be altered for that particular lighting unit 10.

1. A device comprising a screen for displaying a graphical user interface, wherein the device is configured to control a lighting property of a lighting unit of a plurality of lighting units, wherein the device is configured to display a plurality of lighting-related user interface elements on the screen of the device, wherein each lighting-related user interface element includes a photograph-based picture of the corresponding lighting unit in an application environment, wherein each lighting-related user interface element is configured to control the lighting unit light of the corresponding lighting unit, and wherein each lighting-related user interface element is configured to show a lighting effect corresponding to the lighting property of the corresponding lighting unit.

2. The device according to claim 1, further comprising a camera, wherein the device is further configured to convert a photograph captured with the camera to a photograph-based picture for use in a lighting-related user interface element.

3. The device according to claim 1, wherein the device is a portable device selected from the group consisting of a cell phone, a personal digital assistant (PDA), a Smartphone, a tablet, an ultrabook, a laptop, and a device integrated into what a user is wearing.

4. The device according to claim 1, further comprising a processor configured to render the photograph-based picture as a function of the actual lighting property of the corresponding lighting unit.

5. The device according to claim 1, wherein the device is configured to provide a glow as lighting effect around at least part of an icon comprising the photograph-based picture of the corresponding lighting unit.

6. The device according to claim 1, wherein each lighting-related user interface element comprises a widget with a graphical element configured to control at least one of the lighting properties of the lighting unit light, and wherein the graphic element has one or more abilities selected from the group consisting of being scalable in size, being rotatable, being draggable, and being scrollable.

7. The device according to claim 1, wherein the device is further configured to control a lighting property selected from the group consisting of intensity, saturation, color, beam shape, beam direction, beam color distribution, a dynamic lighting property, a biological lighting property, and a lighting menu.

8. A method of controlling a lighting property of a lighting unit of a plurality of lighting units by means of the device according to claim 1, the method comprising selecting one of the lighting units by choosing the corresponding lighting-related user interface element and changing a property of the lighting unit light from a first to a second state, and wherein the lighting effect of the corresponding lighting-related user interface element changes from a first state to a second state corresponding to the change from the first to the second state of the property of the lighting unit light of the lighting unit.

9. The method according to claim 8, further comprising rendering the photograph-based picture as a function of the actual lighting property of the corresponding lighting unit.

10. The method according to claim 8, further comprising providing a glow as lighting effect around at least part of an icon comprising the photograph-based picture of the corresponding lighting unit, and rendering the glow as a function of the actual lighting property of the corresponding lighting unit.

11. A computer program enabled to carry out the method according to claim 8.

12. A record carrier storing a computer program according to claim 11.

13. The method according to claim 8 for controlling a lighting property of a lighting unit of a plurality of lighting units in a space.

14. The method according to claim 13, further comprising a calibration for one or more of (a) allowing the device to learn the plurality of lighting units in the space, including capturing photographs of each lighting unit and attributing photographs to lighting-related user interface element, and (b) learning the lighting properties of each lighting unit.

15. Lighting system comprising a plurality of lighting units and one or more control units, wherein the one or more control units are configured to control a lighting property of a lighting unit of the plurality of lighting units, and wherein the one or more control units are configured to be controlled via a device according to claim 1.
